(19) United States
(12) Patent Application Publication
(10) Pub. No.: US 2006/0223569 A1
(43) Pub. Date: Oct. 5, 2006

(54) Handheld medium probe for managing wireless networks

(75) Inventors: Arthur John Collmeyer, Incline Village, NV (US); Thomas Smith Hedges, Monte Sereno, CA (US)

Correspondence Address: Arthur J. Collmeyer, P.O. Box 6874, Incline Village, NV, 89450, US

(73) Assignee: Mithril, LLC

(21) Appl. No.: 11/098,137

(22) Filed: Apr. 4, 2005

(51) Int. Cl. H04M 1/00

(52) U.S. Cl. 455/550.1

(57) ABSTRACT

A portable, battery-powered device includes a human interface mechanism for the purpose of enabling human interaction, comprising tactile inputs via a keypad and visual outputs via an alphanumeric display; a computing platform for the purpose of hosting network management software, comprising microprocessor, memory and input/output means; a wireless router for the purpose of enabling said portable, battery-powered device to perform, without limitation, the network-specific functions of any node in the network; and network management software enabling said portable, battery-powered device to perform all the critical functions of network management, including the deployment, identification, registration, and configuration of each node in the network, and the detection, diagnosis, troubleshooting, and repair of network failures, using in situ methods. The network management software supports deployment and maintenance of wireless networks with no single point of failure, including medium failure.

### CROSS REFERENCE TO RELATED APPLICATIONS

N/A

### STATEMENT REGARDING FEDERALLY SPONSORED RESEARCH OR DEVELOPMENT

N/A

### BACKGROUND OF THE INVENTION

The invention pertains generally to the field of network management, and more particularly to the management of wireless networks including wireless sensor networks.

For nearly 20 years, wired data networks known as Local Area Networks (LANs) have been deployed to connect workstations within the corporate environment, enabling dramatic improvements in workgroup productivity. To insure the operational effectiveness of these networks, the Simple Network Management Protocol (SNMP) has evolved, along with SNMP-based Network Management Systems (NMS) and Agents. These systems, together with a variety of support systems for the diagnosis and repair of network deficiencies and malfunctions, have enabled the development of large, high-availability wired LANs.

With the introduction of the Wireless Local Area Network (WLAN), the challenge of maintaining high-availability has increased substantially, as new environmental factors come into play. As a result, Network Management Systems and Agents are being evolved to support the peculiar requirements of WLANs.

At the same time, low cost wireless technology is enabling new classes of wireless networks including Wireless Sensor Networks (WSN) for diverse applications (e.g., the Home Automation Network). Inasmuch as these networks are coming into being on the heels of the first commercial WLAN deployments, there is very little wireless network management experience available on which to base the design of the Network Management System, Agent, and support systems for a WSN (assuming SNMP or a variant of SNMP is useful in these environments).

Many if not most of the methods and devices critical to the effective management of WSNs will likely evolve as adaptations of the methods and devices proven effective in the management of WLANs. But new methods and devices, unique in form and function, will be required to support the unique requirements of WSN applications. To the extent these new methods and devices are scalable, they may be retrofitted for WLAN application as well.

To illustrate the unique requirements of the new classes of networks, consider the Home Automation Network (HAN). Its unique requirements derive from a number of differentiating factors:

1) The physical and electromagnetic environment of the home

2) The limited technical training of the typical homeowner, and

3) The limited budget (time and money) available for HAN management, per se

Unlike offices and office buildings, homes come in a tremendous variety of shapes and sizes. This implies a tremendous variation in the span and (network) topology required to serve Home Automation applications. The EMI environment is likewise apt to vary widely from home to home. This is not to suggest that the radio frequency sources are radically different; rather that the medium is much less homogeneous than the office. Offices often have cubicles instead of walls; homes, on the other hand have lots of walls, often with very large mirrors.

Offices typically employ/assign a network administrator, trained to monitor the performance of the network and take corrective action when network problems are detected. Homes will not have trained network administrators; homeowners will expect to be able to detect network problems and repair them using common knowledge, just as they replace burnt out light bulbs and depleted smoke-detector batteries. Complex Network Management Systems and diagnostic tools, such as present-day network sniffers, are neither useful nor affordable to the typical homeowner.

For these reasons, there is a need for new methods and devices to simplify the management of Wireless Sensor Networks in general, and Home Automation Networks, in particular.

### BRIEF SUMMARY OF THE INVENTION

The primary objective of this invention is to provide new methods and devices to simplify the deployment and maintenance of wireless networks where the requirement for high availability must be satisfied at very low cost. An example of such a network is the Home Automation Network.

To this end, a portable, battery-powered device for deploying and maintaining a wireless network, such as the Home Automation Network, is disclosed. The portable, battery-powered device includes a human interface mechanism for the purpose of enabling human interaction, comprising tactile inputs via a keypad and visual outputs via a computer-generated display; a computing platform for the purpose of hosting network management software, comprising microprocessor, memory and input/output means; a wireless router for the purpose of enabling said portable, battery-powered device to perform, without limitation, the network-specific functions of any node in the network; and network management software enabling said portable, battery-powered device to perform all the critical functions of network management, including the deployment, identification, registration, and configuration of each node in the network, and the detection, diagnosis, troubleshooting, and repair of network failures, using in situ methods.

The uniqueness of this portable, battery-powered device does not derive from its construction, but rather from the unique methods applied to accomplish its purpose—methods that leverage its portability, enabling the site-specific tasks of network management to be performed efficiently in situ, that is on the site of the task, and from its focus on medium failures as well as hardware failures, in the deployment and maintenance of wireless networks.

Consider, for example, the task of deploying wireless Backbone Nodes so as to have no single point of failure. Absent a portable Backbone Node with a GO/NO GO indicator, a homeowner, for example, would have no convenient way of intelligently and efficiently selecting sites for Backbone Nodes. Absent the means to analyze a network for single points of failure, a homeowner would have the option of overspending on Backbone Nodes or living with the vulnerability of single points of failure. The invention described herein combines portability with network analysis and optimization means, so that a homeowner can simply walk the premises, take readings at available AC outlets (Backbone Nodes are generally powered off the AC mains), and install Backbone Nodes as directed until no further Backbone Nodes are required.

In a preferred embodiment, the network management software supports the deployment and maintenance of wireless networks with no single point of failure, including medium failure.

In a second preferred embodiment, the portable, battery-powered device facilitates in situ methods by duplicating the function of a suspect node or an about-to-be deployed node, in order to verify its functionality (in the case of the former) or its utility (in the case of the latter).

In a third preferred embodiment, the portable, battery-powered device facilitates in situ methods by adapting its transmission and reception characteristics to approximate those of a suspect node or an about-to-be deployed node, in order to verify its functionality (in the case of the former) or its utility (in the case of the latter).

Those skilled in the art will understand that the methods and devices of the present invention may be applied across a broad spectrum of wireless networks, where the requirement for high availability must be satisfied at very low cost.

The following figures and descriptions disclose other aspects and advantages of the present invention.

### BRIEF DESCRIPTION OF THE DRAWINGS

FIG. 1 A simple diagram of a Home Automation System

FIG. 2 Canonical Connections of a Home Automation Network

FIG. 3 A simple diagram of a Home Automation Network

FIG. 4 A simple diagram of a Home Automation Network

FIG. 5 A simple diagram of a Home Automation Network

### DETAILED DESCRIPTION OF THE INVENTION

To facilitate the detailed description of the invention, it is useful to describe it in the context of a specific application. For this purpose, we have chosen the Home Automation Network as the context for the detailed description. Those skilled in the art will appreciate the applicability and utility of the invention across a broad spectrum of Wireless Sensor Networks and other networks, where the requirement for high availability must be satisfied at very low cost.

Wireless Home Automation

Low cost wireless technology is making it practical to interconnect scores of low cost sensors and switches for the purpose of monitoring and controlling many functions in our homes. Home Automation, as it is called, involves security and safety systems, lighting, heating/air conditioning and other utility systems. These systems will be integrated via a central monitoring and control facility that was impractical to implement before the advent of low cost wireless technology.

Before the advent of wireless, Wired Home Automation Systems (and Wired Home Automation Networks) were generally installed and maintained by electrical contractors, to insure safety and conformance to building codes. With the advent of wireless, the expectation is that Home Automation Systems (and Home Automation Networks) will be do-it-yourself projects. To meet this expectation, the Home Automation Network will have to be easy and intuitive to setup and to maintain. In addition, homeowners will need a tool to continuously monitor the integrity of the HAN, to diagnose changes as detected, to alert them to any problem requiring their intervention, and guide them through the trouble-shooting and repair of the problem. A circuit breaker could trip, limiting the network's reach; or someone could hang a lovely gilded mirror in the hallway, disrupting wireless traffic in the vicinity of the mirror; and the list goes on.

The Home Automation System

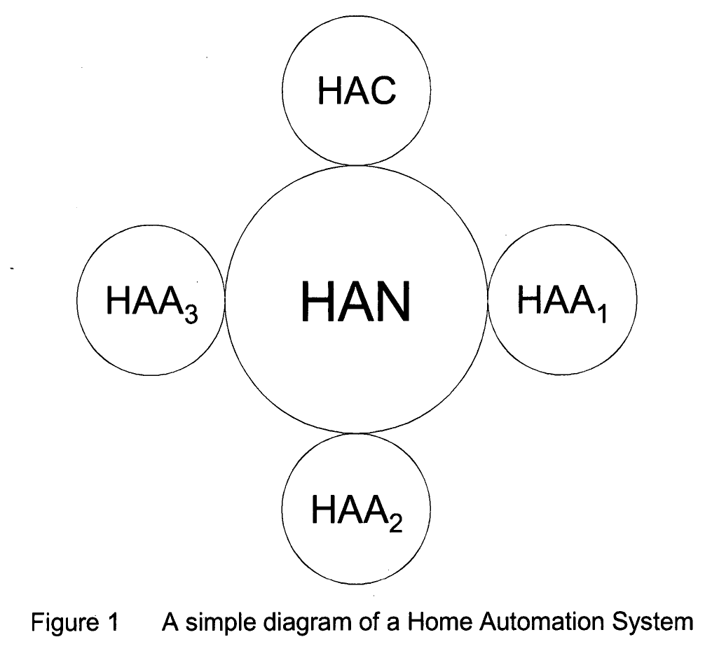

A Home Automation System (FIG. 1) consists of an ensemble of Home Automation Appliances interconnected via a wireless network (aka the Home Automation Network) and controlled via an interactive keyboard display (aka the Home Automation Console). Home Automation Appliances (HAA) includes all forms of sensors, switches and communication devices (alarms, displays, etc.) critical to the improvement of comfort, convenience, safety, security, and efficiency of the home. The Home Automation Network is the hardware and software that allows Home Automation Appliances to be added easily (to the Home Automation System), to interoperate smoothly, and to be continuously accessible to the Home Automation Console. The Home Automation Console (HAC) is the hardware and software that allows the homeowner to prescribe and control the operation of the Home Automation System.

The Home Automation Network

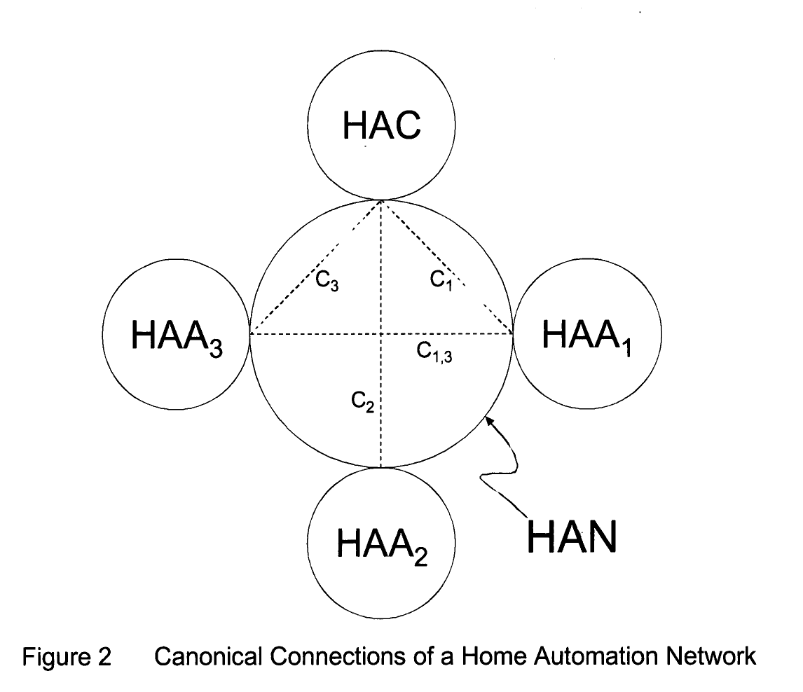

As suggested in the preceding paragraph, the HAN is the glue that holds the pieces (HAAs and HAC) together. More precisely, the HAN provides the wireless connections required for all essential interactions between individual HAAs and the HAC, and on occasion, between or among HAAs. These connections are referred to as the Canonical Connections (see FIG. 2).

The Home Automation Network thus consists of 1) the Network Nodes, wireless transceivers embedded in the HAAs and HAC, for the purpose of sending (and receiving) messages from HAA to HAC, HAC to HAA, or HAA to HAA, 2) the mechanism for intelligently and efficiently delivering these messages from origin to destination, and 3) the interconnect medium, the ether through which these messages must pass. The mechanism for delivering messages may be distributed across the ensemble of HAAs and HAC, or it may take the form of an ensemble of wireless routers, wireless components deployed specifically for the purpose of message delivery, or it may be some combination of the two. In the framework of Zigbee, an open network standard developed to serve the Home Automation application, the mechanism for delivering messages takes the form of a mesh of wireless routers (Full Function Nodes in Zigbee parlance). Messages received at any of these wireless routers (from an HAA or HAC) are routed, using multiple hops if necessary, to their intended destination.

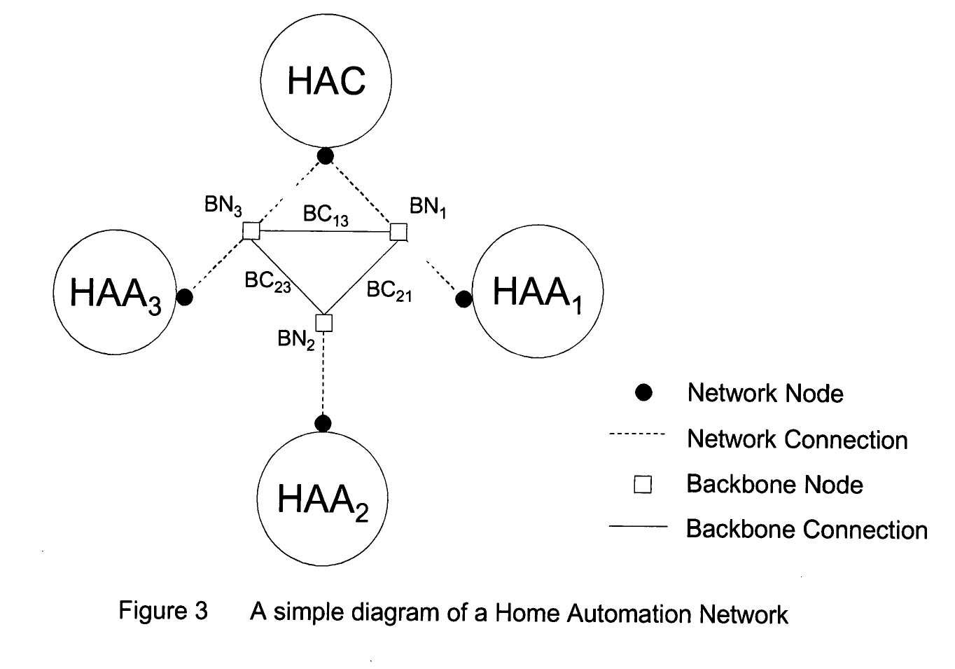

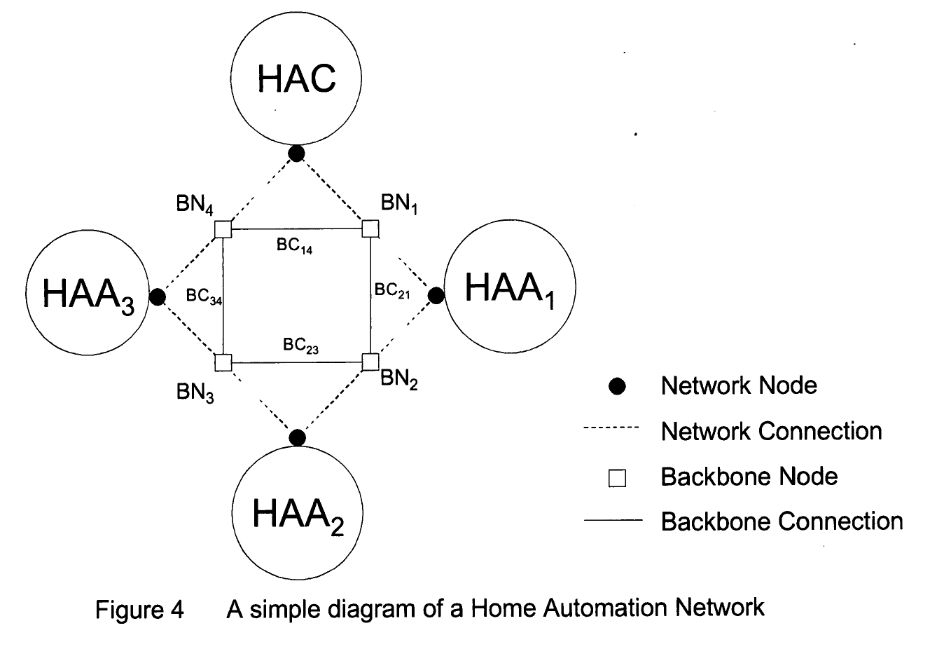

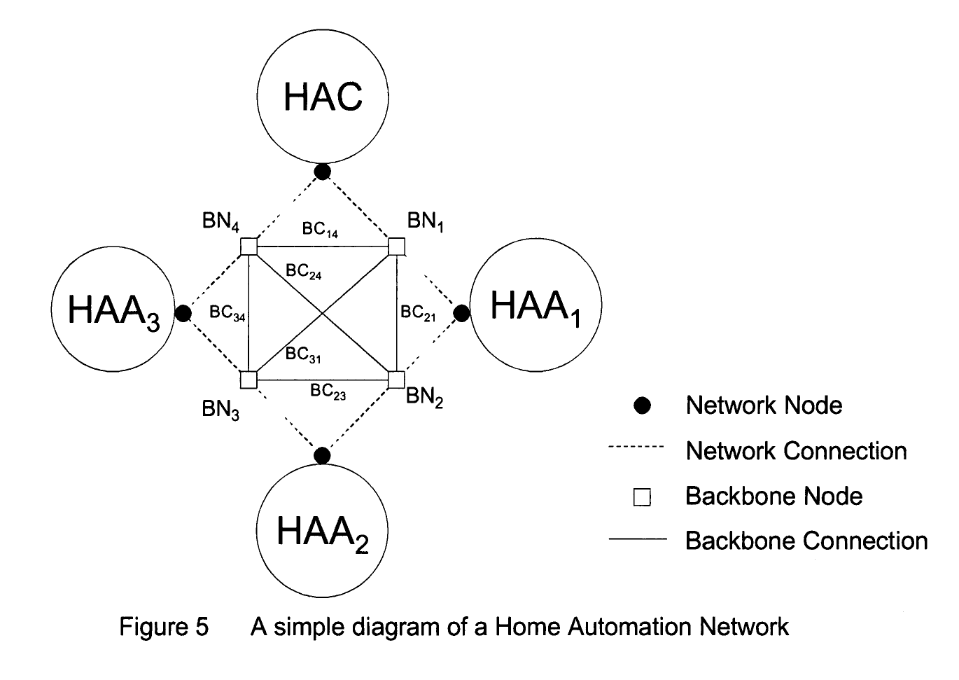

FIG. 3 describes a Home Automation Network featuring a triangular mesh of wireless routers deployed specifically for the purpose of message delivery. Meshes such as this are referred to as Home Automation Backbones; their constituent wireless routers, as Backbone Nodes; and the constituent point-to-point connections between Backbone Nodes, as Backbone Connections. The Home Automation Network is thus comprised of the Home Automation Backbone (HAB) and the ensemble of point-to-point connections linking HAAs and HAC to the HAB, referred to as Network Connections. The network of FIG. 3 has numerous single points of HAN failure. In FIG. 4, a quadrilateral mesh of Backbone Nodes is deployed, enabling three additional Network Connections and eliminating all single points of HAN failure. FIG. 5 describes how additional Backbone Connections can reduce the number of hops required to complete a Canonical Connection.

The Home Automation Backbone is useful in enabling the HAN to accommodate the rigid physical location and power consumption constraints imposed on HAAs, by virtue of their specific applications. Inconspicuous Backbone Nodes, powered off the AC mains, can be deployed where needed. And with proper placement and a handful of additional BNs, single points of HAN failure could be eliminated.

To maximize the availability of the HAN as well as its performance, and to minimize the vulnerability of the HAN, a Home Automation Network Management System is required.

The Home Automation Network Management System

As indicated, the primary purpose of the Home Automation Network Management System (HANMS) is to enable the homeowner, with minimum effort and training, to set up and maintain the HAN. The task of setting up the HAN (and adding to it as new applications are identified) is all about the installation (and the occasional upgrade) of the HAB, with a focus on guiding the homeowner through the intelligent and efficient deployment of Backbone Nodes. The task of maintaining the HAN involves continuously monitoring the status/integrity of the HAN, detecting and diagnosing network failures, alerting the homeowner to problems requiring their intervention, and guiding them through the troubleshooting and repair of the problems as detected. As with set up, troubleshooting and repair will frequently involve the deployment/redeployment of BNs.

In the current context, the term Home Automation Network Management System (HANMS) is used to describe an ensemble of subsystems spanning the range of functionality of the numerous subsystems that comprise a typical SNMP-based network management toolkit, including the Network Management System, Agents, and support systems for diagnosis and repair. The purpose of HANMS is for the most part identical to that of SNMP-based network management toolkits proven effective in wired LANs. The differences are manifest in the types of problems and the manner of resolution.

Problems on wired LANs are rarely caused by an unreliable medium; more often than not they result from the traffic generated by a diverse set of applications with conflicting demands for bandwidth and quality of service. Solutions to LAN problems generally fall under the heading of traffic management. The HAN, in contrast, carries relatively homogeneous traffic; however, the medium is unreliable. Solutions to HAN problems will need to address the medium as a point of possible failure. To facilitate network deployment, tools to cost-effectively eliminate single points of failure will become important. To maintain wireless networks new medium diagnostic tools will be required. To be effective, these tools will rely on some mechanism for “probing” the medium

Because they are similar in purpose, Home Automation Network Management Systems will likely bear a resemblance to SNMP-based network management toolkits, but to be effective, the HANMS will need to incorporate new approaches, methods, and devices.

A Focus on the Medium

The requirements of Home Automation Network Management Systems (outlined in a previous paragraph) present difficult challenges to the designers of HANMSs. First and foremost is the challenge posed by the medium As the most fickle, most spontaneous component of the HAN, the medium is apt to be the most likely cause of HAN failures, with power failure (circuit breakers, batteries) being the next most likely. One approach to managing the HAN for high availability is to:
1) Build out the HAN eliminating Single Points of HAN Failure (SPF)
2) Continuously monitor the integrity of the HAN, and
3) Diagnose and repair detected failures (BN or BC) in a time short compared to the MTBF

The foregoing approach presents a number of specific technical challenges. The first challenge is the challenge of deploying Backbone Nodes intelligently and efficiently in such a way that single points of failure (any BN or BC whose failure would break one or more of the Canonical Connections) are eliminated. The second challenge is the challenge of detecting failures in any of the BNs or BCs essential to the elimination of single points of HAN failure. The third challenge is the challenge of accurately diagnosing detected failures and “overseeing” the repair, which may include deployment/redeployment of a BN (see the first challenge).

These challenges can only be met with the help of methods and devices that focus on the medium as both a probable and problematic point of failure.

The Handheld Medium Probe

The Handheld Medium Probe (HMP) is a tool for managing the Home Automation Network. HMP is a battery-powered device, recharged by cradle or by cord, so that it is continuously available for use when and where it is needed. The human interface includes function keys, a keypad, and a display. Stylus or touch screen input may also be incorporated. Inside is a wireless router and the ubiquitous microprocessor with its memory. The interface to the outside world (apart from its charger) is the wireless transceiver of the wireless router. Hosted on this platform is a suite of software modules that transforms it into a uniquely effective tool for managing the Home Automation Network. Because the work of network management often requires privileges and prerogatives reserved for a designated network controller, such as the Zigbee Control Node, the suite may also include network control software.

The uniqueness of this portable, battery-powered device does not derive from its construction, but rather from the unique methods applied to accomplish its purpose—methods that leverage its portability, enabling the site-specific tasks of network management to be performed efficiently in situ, that is on the site of the task; and from its focus on medium failure as well as hardware failure in the deployment and maintenance of HANs.

Consider, for example, the task of deploying Backbone Nodes so as to have no single point of HAN failure. Absent a portable Backbone Node with a GO/NO GO indicator (as in HMP), a homeowner would have no convenient way of intelligently and efficiently selecting sites for Backbone Nodes. Absent the means to analyze the vulnerability of a network to single points of failure, a homeowner would have the option of overspending on Backbone Nodes or living with the vulnerability of single points of failure. HMP, however, combines portability with network analysis and optimization means, so that a homeowner can simply walk the premises, take readings at available AC outlets (Backbone Nodes are generally powered off the AC mains), and install additional Background Nodes as directed by HMP until no further Backbone Nodes are required.

The task of repairing a broken connection could become a nightmare. Without the aid of HMP, a homeowner would have to locate the end points of the broken connection, insure that both have power, and then begin the hit-or-miss process of relocating one or both until the connection is repaired (along with all the others broken in the process). With HMP, the homeowner is able to test alternate sites and determine which BN should be moved and where, and then proceed with its relocation. Once again, portability is leveraged to preserve the homeowners time and treasure without compromising network vulnerability.

Other more mundane tasks, such as the identification of new Home Automation Appliances are likewise made simpler and less error-prone through the portability of HMP. The purpose of identification is to add the new appliance officially to the HAN. Before a new HAA is identified, it is for all intents and purposes one of a number of stray dogs looking for a home. For this reason, identification frequently involves recognition by the network followed by an acknowledgement by the appliance, in the form of a blinking light, sound or motion. To be able to identify and then register a new HAA at the site where it is deployed, whether garden, garage or attic, insures that the task can be done accurately and efficiently.

While they do not leverage portability, background tasks, such as the continuous monitoring of the HAN, keep the HMP busy round the clock. It should be noted, however, that the network analysis performed during continuous monitoring is largely the same as that performed during installation and repair.

HMP Principles of Operation

HMP has several modes of operation, including Add HAA, Define Canonical Connections, Place BN, Add BN, Add HMP, Eliminate SPF, Troubleshoot HAN, Monitor HAN, and Monitor HMP. The principles of operation in each of these modes are best described in the context of their usage. The following paragraphs describe how HMP is used and how it operates under a variety of scenarios.

Installing/Extending the Home Automation Backbone

Once the initial phase of Home Automation Appliances have been installed, identified and registered (see description below), and again whenever a new Home Automation Appliance is added to the ensemble, the installation/extension of the Home Automation Backbone can begin. On the initial installation, HMP is switched into Place BN Mode, and physically moved from one potential BN site to another. At each site, HMP records a Site Label (e.g., a room designator), scans the gamut of HAAs, and compiles a Site Profile—a list of accessible Network and Backbone Nodes, together with their Relative Signal Strength Indicator (RSSI).

Once all the potential sites have been “probed”, HMP compiles three Site Sets. The first, SS0, is the minimal set of sites that provides the Canonical Connections, subject to limitations on minimum RSSI and maximum number of hops. The second set, SS1, consists of SS0 plus one additional site selected to minimize the number of single points of HAN failure (as defined earlier). The third set, SS2, is the minimal set of sites essential to eliminate single points of failure. In the event HMP is unable to generate SS0, SS1, and SS2 from the probed sites, HMP will direct the homeowner to “probe” additional sites, until it is able to generate SS0, at least. In no case will two sites with similar Site Profiles be included in SS0. The homeowner is then offered the choice of SS0, SS1, or SS2. Having chosen, he is guided site-by-site to the selected sites to perform the BN installation, identification, registration, and configuration (using Add BN Mode, similar to Add HAA Mode).

In the case where a Home Automation Appliance is added to an existing Home Automation System, it may be necessary to extend the backbone to accommodate the new HAA. After the new HAA has been installed, identified, and registered, HMP attempts to access the HAA via the Home Automation Backbone. If the attempt fails, HMP alerts the homeowner of the failure, diagnoses the failure, and compiles a Troubleshoot Checklist and one or more On-Site Tests. At the initiative of the homeowner, HMP is switched to Troubleshoot HAN Mode and carried to the vicinity of the HAA to verify that backbone extension is required and “oversee” the placement of new Backbone Node(s) as required (see below).

Eliminating Single Points of HAN Failure

If, after installing the Home Automation Backbone, a homeowner should elect to upgrade it by eliminating single points of HAN failure, HMP is switched into Eliminate SPF Mode, and physically moved from one potential BN site (vacant, of course) to another. At each site, HMP records a Site Label (e.g., a room designator), scans the gamut of HAAs, and compiles a Site Profile—a list of accessible Network and Backbone Nodes, together with their Relative Signal Strength Indicator (RSSI).

Once all the potential add-on sites have been “probed”, HMP compiles two Site Sets. The first, SSAddOnly, is generated by adding (to the existing Site Set) the minimum number of BNs necessary to eliminate single points of HAN failure. The second set, SSAddDelete, is generated when and if it is possible to eliminate a BN site from SSAddOnly without introducing a single point of HAN failure. The homeowner is offered the choice of SSAddOnly or SSAddDelete. Having chosen, he is guided site-by-site to the Add site(s) and (if applicable) the Delete site to perform the BN installation, identification, and registration (using Add BN Mode, similar to Add HAA Mode).

Adding a Home Automation Appliance

The first task after the Home Automation Appliance is installed is that of identification of the HAA being added. Each ZigBee node, for example, has a unique 64-bit internal binary MAC address; while this might seem to simplify the identification problem, in fact it does not. Consider that a homeowner could bring a sack full of HAAs home, each equipped with fresh batteries and screaming to be identified. Since misidentifying a new HAA can compromise the integrity of the network, HMP (in Add HAA Mode) attempts to verify the identity of each new HAA as part of the identification process. This can be done in one of two ways: either HMP signals the new HAA to indicate through blinking light, sound or motion that it is the “one” the homeowner believes he is identifying; or the homeowner presses a button or flips a switch on the new HAA and checks for a visual confirmation on the HMP. For some HAAs, either approach may be used.

Once positively identified, the registration of the new HAA can proceed. Some bits of the Zigbee 64-bit MAC address of the device tell HMP what class of appliance it is, and in many cases specify exactly what the appliance can do. HMP presents a predefined list of typical locations for the HAA, e.g. hallway, kitchen, or master bedroom, that can be simply clicked-on, as well as allowing a customized location to be typed in when the predefined list does not contain the needed location.

Once the HAA is identified and registered, HMP attempts to access the HAA via the Home Automation Backbone. If the attempt fails, HMP alerts the homeowner of the failure, diagnoses the failure, and compiles a Troubleshoot Checklist and one or more On-Site Tests—tests run (on MHP) at the sites of suspected failures, to confirm the diagnoses. At the initiative of the homeowner, HMP is switched to Troubleshoot HAN Mode and carried to the vicinity of the HAA to verify that backbone extension is required and “oversee” the placement of new Backbone Node(s) as required (see below).

Troubleshooting and Repairing Backbone Failures

When a failure is detected, HMP alerts the homeowner, diagnoses the failure, and compiles a Troubleshooting Checklist and one or more On-Site Tests. At the initiative of the homeowner, HMP is switched into Troubleshoot HAN Mode and carried to the vicinity of the failure. If prior to the failure in question, the HAN or the affected Canonical Connection had no single points of failure, the repair of a simple failure is likely to be a straightforward procedure. If a BN has failed, diagnostics will be able to guide the homeowner to the failed BN, where the failure will be verified (by running an HMP On-Site Test) as a preliminary to corrective action (reset circuit breaker, replace BN). If a BC has failed and the diagnosis points to a medium failure (a radio frequency nuisance, or a new mirror on the wall, or whatever), it can be verified by running HMP On-Site Tests at both ends of the broken Backbone Connection. Corrective action options, in this case, are either to eliminate the radio frequency nuisance or add/redeploy one or more Backbone Nodes. In the event the latter is required, HMP is switched into Eliminate SPF Mode and the repair completed as described above.

If a failure is detected at an apriori single point of HAN failure, the diagnosis will be more complicated owing to the fact that the a portion of the HAN has become isolated as a result of the failure. In the event of a simple failure, dividing the network into two parts, effective diagnosis can proceed once HMP can reach both parts. As above, HMP is switched into Troubleshoot HAN Mode and carried to the vicinity of the failure—in this case, to a point known to be or believed to be at the boundary between the two isolated parts. The failure is verified by running HMP On-Site Tests, and corrective action proceeds as described above.

Monitoring the Home Automation Network

HMP switches into Monitor HAN Mode whenever an installation, upgrade, or troubleshooting session is terminated. In this mode it continuously monitors the integrity of the HAN. While it monitors the integrity of Canonical and Backbone Connections, it also meters the performance of the HAN, in particular, the latency and throughput of the HAN. This, as well as the operations described above, is accomplished collaboratively with the Backbone Nodes.

In this mode HMP sounds alerts as failures are detected, as well as publishing periodic reports on the state of the HAN, including the margin to minimal performance metrics, set by the homeowner (defaults are provided). As margins dwindle, HMP publishes Recommendations—options available to eliminate performance bottlenecks, ordered by their expected improvement.

Eliminating HMP as a Single Point of Failure

In general, tools for managing the Home Automation Network do not present a threat to the integrity of the HAN, nor should they. The same is true of the HMP, by design. Its failure, however, could contribute indirectly to a breach of network integrity. For example, if the HMP were to fail in Monitor HAN Mode, network failures would go undetected and unrepaired, and eventually a Canonical Connection might be broken.

To minimize the possibility that an HMP failure could contribute indirectly to a breach of network integrity, HMP is designed to operate collaboratively with a second (backup) HMP. In the event a homeowner opts to acquire a Backup HMP, it is identified, registered, and configured by the HMP, in Add HMP Mode. Once the Backup HMP is configured, the HMP insures that all critical network configuration data are backed up on the Backup HMP; and the Backup HMP continually monitors HMP, in Monitor HMP Mode. In the event Backup HMP detects a failure in HMP, it alerts the homeowner of the HMP failure, and assumes the role of HMP.

Other Applications of the Handheld Medium Probe

The foregoing detailed description of the invention has focused on the Home Automation Network, in order to clarify the methods and devices that are the subject of this patent application. The same or similar methods and devices could be applied to other types and classes of networks.

We claim:

1. A portable, battery-powered device for managing wireless networks, comprising:
Human interface means for the purpose of enabling human interaction, comprising tactile inputs via a keypad and visual outputs via an alphanumeric display, and
Computing platform means for the purpose of hosting network management software, comprising microprocessor, memory and input/output means, and
Wireless router means for the purpose of enabling said portable, battery-powered device to perform, without limitation, the network-specific functions of any node in the network, and
Network management software enabling said portable, battery-powered device to perform all the critical functions of network management, including the deployment, identification, registration, and configuration of each node in the network, and the detection, diagnosis, troubleshooting, and repair of network failures, using in situ methods.

2. The portable, battery-powered device of claim 1, wherein the human interface means comprises audible outputs in addition to visual outputs.

3. The portable, battery-powered device of claim 1, wherein the tactile input means include (in addition to the keypad) one or more of the following: function keys, thumbwheel, stylus, and touch screen.

4. The portable, battery-powered device of claim 1, wherein the visual output means include (in addition to the alphanumeric display) one or more of the following: light emitting devices and graphic displays.

5. The portable, battery-powered device of claim 1, wherein the wireless router means include a wireless transceiver device.

6. The portable, battery-powered device of claim 1, wherein the wireless router means includes message routing software modules hosted on the computing platform means.

7. The portable, battery-powered device of claim 1, wherein the network management software supports the deployment and maintenance of wireless networks with no single point of failure.

8. The portable battery-powered device of claim 7, wherein single points of failure include the failure of the medium, resulting in a broken connection between two intercommunicating nodes of the network.

9. The portable, battery-powered device of claim 1, wherein certain of the in situ methods are facilitated by the approximate co-location of the portable, battery-powered device either at the site of a suspect node of the network or at the site of an about-to-be-deployed node.

10. The portable, battery-powered device of claim 9, wherein the co-located portable, battery-powered device duplicates the function of the suspect node or the about-to-be deployed node, in order to verify its functionality (in the case of the former) or its utility (in the case of the latter).

11. The portable, battery-powered device of claim 10, wherein the co-located portable, battery-powered device adapts it transmission and reception characteristics to approximate those of the suspect node or the about-to-be deployed node, in order to verify its functionality (in the case of the former) or its utility (in the case of the latter).

12. A method of managing the deployment and maintenance of a wireless network by means of a portable, battery-powered device comprising:
Human interface means for the purpose of enabling human interaction, comprising tactile inputs via a keypad and visual outputs via an alphanumeric display, and
Computing platform means for the purpose of hosting network management software, comprising microprocessor, memory and input/output means, and
Wireless router means for the purpose of enabling said portable, battery-powered device to perform, without limitation, the network-specific functions of any node in the network, and
Network management software enabling said portable, battery-powered device to perform all the critical functions of network management, including the deployment, identification, registration, and configuration of each node in the network, and the detection, diagnosis, troubleshooting, and repair of network failures, using in situ methods.

13. The method of claim 12, wherein the deployment of backbone nodes is accomplished in part by cataloguing and characterizing possible sites with the aid of the portable, battery-powered device as it is transported to each of the possible sites, for the purpose of recording the strength of signals available at said sites.

14. The method of claim 12, wherein the deployment of backbone nodes is accomplished in part by selecting deployment sites so as to provide backbone connections sufficient to eliminate single points of medium failure.

15. The method of claim 12, wherein the identification of a new network node is accomplished by transporting the portable, battery-powered device to the location of the new node, where the portable device is applied to unambiguously identify the node in question in the presence of one or more unidentified devices.

16. The method of claim 15, wherein the unambiguous identification is accomplished through a stimulus/response sequence initiated by the portable device.

17. The method of claim 12, wherein the registration of a new network node is accomplished by transporting the portable, battery-powered device to the location of the new node, where the portable device is applied to record the information essential to the registration of the new node.

18. The method of claim 12, wherein the redeployment of backbone nodes is accomplished in part by cataloguing and characterizing possible sites with the aid of the portable, battery-powered device as it is transported to each of the possible sites, for the purpose of recording the strength of signals available at said sites.

19. The method of claim 12, wherein the verification of a node failure is accomplished by transporting the portable, battery-powered device to the site of the suspected failure, and running an On-Site Test to verify the failure of the suspect node.

20. The method of claim 12, wherein the verification of a medium failure is accomplished by transporting the portable, battery-powered device to the vicinity of the suspected failure, and running On-Site Tests on the sites of each end of the broken connection, to verify implicitly the suspected medium failure.

21. The method of claim 12 wherein the diagnosis of a network failure is accomplished in part by transporting the portable, battery-powered device to the vicinity of the failure, where it is applied to effect a connection between two subsets of the network, isolated by the failure, in order that a more comprehensive diagnosis can be completed.
